(19) United States
(12) Patent Application Publication
(10) Pub. No.: US 2025/0160462 A1
(43) Pub. Date: May 22, 2025

(54) APPLICATORS FOR APPLYING EYELASH EXTENSIONS AND METHODS FOR USE AND MANUFACTURE THEREOF

(71) Applicant: Lashify, Inc., North Hollywood, CA (US)

(72) Inventor: Sahara Lotti, North Hollywood, CA (US)

(21) Appl. No.: 19/030,553

(22) Filed: Jan. 17, 2025

Related U.S. Application Data
(63) Continuation of application No. 18/220,609, filed on Jul. 11, 2023, now Pat. No. 12,232,552.
Application No. 18/220,609 is a continuation of application No. 16/810,787, filed on Mar. 5, 2020, now Pat. No. 11,771,158.
Application No. 16/810,787 is a continuation of application No. PCT/US2019/057102, filed on Oct. 19, 2019.
(60) Provisional application No. 62/748,335, filed on Oct. 19, 2018.

(51) Int. Cl. A41G 5/02; A45C 11/00; B65D 85/00

(52) U.S. Cl. CPC A41G 5/02; A45C 11/008; B65D 85/00

(57) ABSTRACT

An applicator includes a first arm and a second arm. Each of the first and second arms includes a medial section extending distally from the proximal end, and a grasping section extending distally from the medial section. The grasping section includes a concave curvature disposed between a first end area and a second end area. A portion of the interior surface of the grasping section of the first arm has a male portion having a protrusion with a concave curvature that longitudinally extends towards the tip to position the concave curvature of the male portion to face opposite the first side of the arm. A portion of the interior surface of the grasping section of the second arm has a female portion with a depression. The male portion and the female portion are designed to crimp natural lashes and the artificial lash extension that are disposed therebetween.

### CROSS-REFERENCE TO RELATED PATENT APPLICATIONS

This patent application is a Continuation of U.S. patent application Ser. No. 18/220,609, filed Jul. 11, 2023, which is a Continuation of U.S. patent application Ser. No. 16/810,787, filed Mar. 5, 2020, which is a Continuation of International Patent Application PCT/US2019/057102, filed Oct. 19, 2019, which claims a benefit of U.S. Provisional Patent Application 62/748,335, filed Oct. 19, 2018, the entire contents of all are hereby incorporated herein by reference in their entirety for all purposes.

### TECHNICAL FIELD

This disclosure relates to applicators for applying eyelash extensions to natural eyelashes.

### BACKGROUND

An applicator can be used to apply an eyelash extension to a natural eyelash of a user via an adhesive. However, the adhesive may not properly adhere to the eyelash extension or the natural eyelash. For example, the adhesive may not spread properly or clump.

### SUMMARY

Broadly, this disclosure enables applicators for applying eyelash extensions and methods for use and manufacture thereof. In particular, these applicators these applicators host male/female tips that can improve application of adhesives to eyelash extensions or natural eyelashes. Regardless of the applicators shaping (e.g., lash curler style) or not shaping the eyelash extensions or the natural eyelashes, the male/female tips aid, enable, or cause spreading of the adhesives (e.g., along male projections, within female depressions) or makes the adhesives less user visible (e.g., minimize clumping of adhesives).

In an embodiment, an applicator comprising: a first arm having a first grasping tip that is arcuate, wherein the first grasping tip has a first inner side hosting a male portion; and a second arm having a second grasping tip that is arcuate, wherein the second grasping tip has a second inner side hosting a female portion, wherein the first inner side faces the second inner side, wherein the male portion and the female portion avoid mating when the first arm and the second arm are at a default position, wherein the male portion and the female portion mate when the first arm and the second arm are at a grasping position.

In an embodiment, a method comprising: causing a lash extension to be grasped between a male portion of a first inner side of a first arcuate tip of a first arm of an applicator and a female portion of a second inner side of a second arcuate tip of a second arm of the applicator while the male portion and the female portion mate and the first inner side faces the second inner side; and causing the lash extension to be released onto a natural lash of the user via not mating the male portion and the female portion while the first inner side faces the second inner side.

Another embodiment of an applicator may include a first arm including a first grasping tip having a first inner side including at least one protrusion that defines a male portion. A second arm may include a second grasping tip having a second inner side including at least one depression that defines a female portion. The first inner side may face the second inner side such that the male portion and the female portion are aligned with one another such that when the first arm and the second arm are in an open position, the male and female portions are separated from one another, and when the first arm and second arm are in a closed position, the male portion and the female portion mate with one another.

Another embodiment of a method may include causing an adhesive holding a lash extension formed of multiple fibers and natural lashes together to be simultaneously grasped between at least one protrusion defining a male portion of a first inner side of a first tip of a first arm disposed on an applicator and at least one depression that defines a female portion disposed on a second inner side of a second tip of a second arm of the applicator, thereby causing the adhesive to be spread along a region between the male and female portions.

One embodiment of a method for redistributing an adhesive applied to a lash extension formed of multiple fibers and natural lashes may include causing the adhesive disposed on the natural lashes and lash extension to extend along a surface of an elongated depression disposed on a first tip of a first arm of an applicator and a surface of an elongated protrusion disposed on a second tip of a second arm when the elongated protrusion is vertically extended into the elongated depression with the adhesive, natural lashes, and lash extension being positioned between the elongated depression and elongated protrusion.

One embodiment of a method of manufacturing an applicator may include forming a first arm including a first grasping tip having a first inner side including at least one protrusion that defines a male portion, and forming a second arm including a second grasping tip having a second inner side including at least one depression that defines a female portion. The first and second arms may be connected at a first end opposite a second end at which the first and second grasping tips are located, and with the first inner side facing the second inner side. The male portion and the female portion may be aligned with one another so that when the first arm and the second arm are in an open position, the male and female portions are separated from one another, and when the first arm and second arm are in a closed position, the male portion and the female portion mate with one another.

### DESCRIPTION OF DRAWINGS

FIGS. 1-8 show a plurality of views of an embodiment of an applicator according to this disclosure.

FIGS. 9-16 show a plurality of views of an embodiment of an applicator according to this disclosure.

FIGS. 17A-17C show a sequence of respectively applying an adhesive to natural lashes, positioning lash extensions on the natural lashes, and using an applicator to fuse the lash extensions to the natural lashes by evenly distributing the adhesive with male/female features on the tips.

FIGS. 18A-18B show a sequence of using tips with male/female features of an applicator to fuse natural lashes and lash extensions.

### DETAILED DESCRIPTION

Generally, this disclosure enables applicators for applying eyelash extensions and methods for use and manufacture thereof. In particular, these applicators host male/female tips that can improve application of adhesives to eyelash extensions or natural eyelashes. Regardless of the specific shape of the applicators, the male/female tips aid, enable, or cause spreading of the adhesives (e.g., along male projections, within female depressions) and/or makes the adhesives less user visible (e.g., minimize clumping of adhesives).

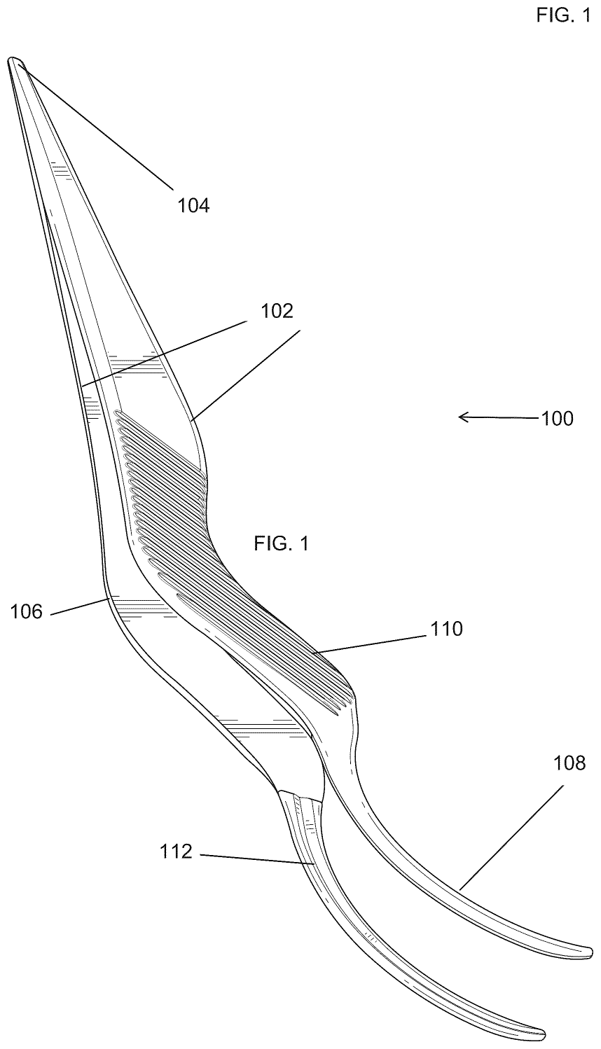

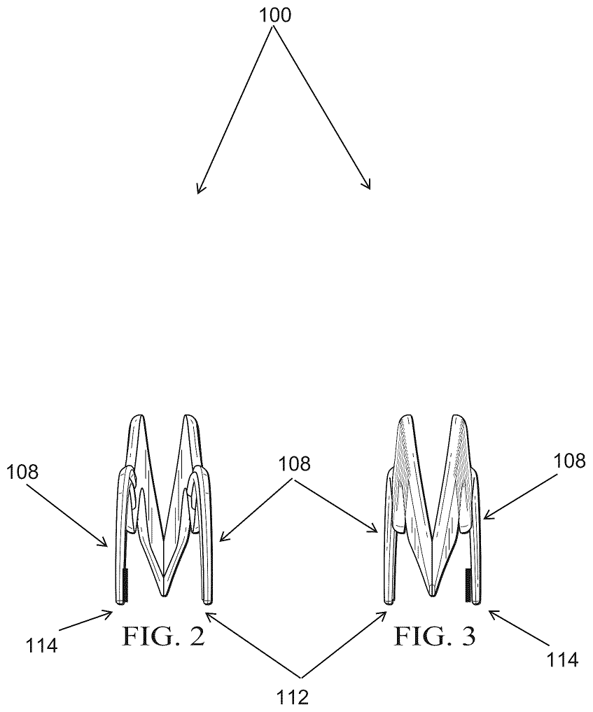

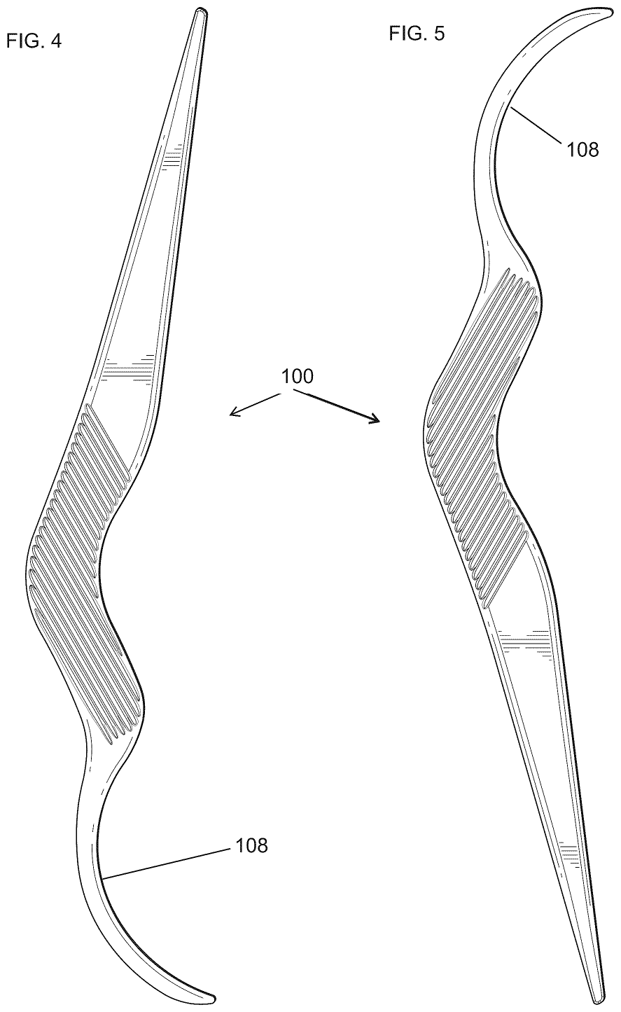

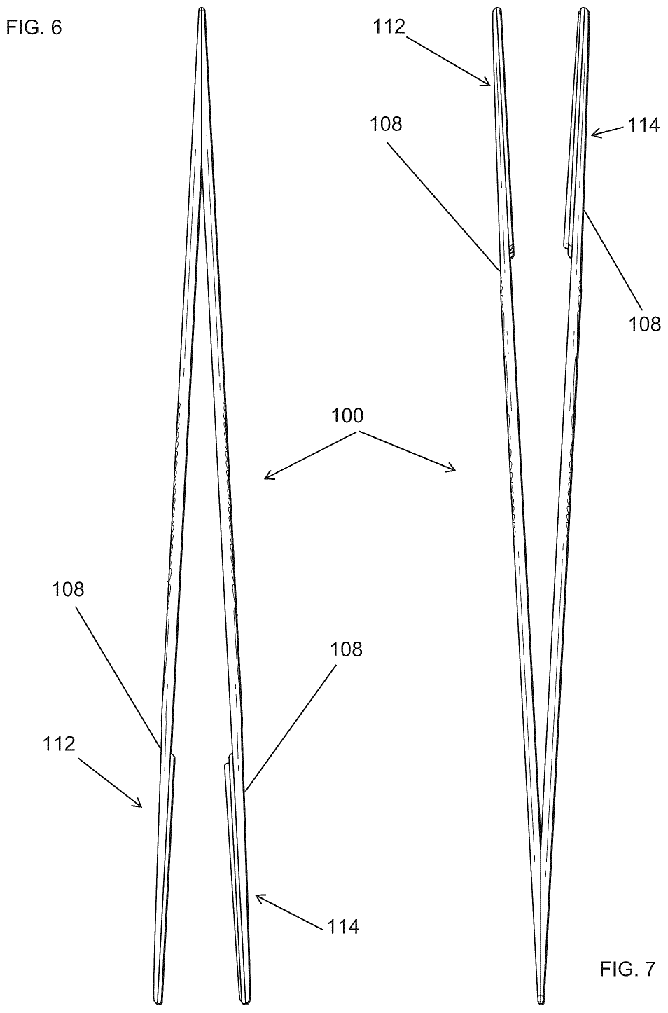

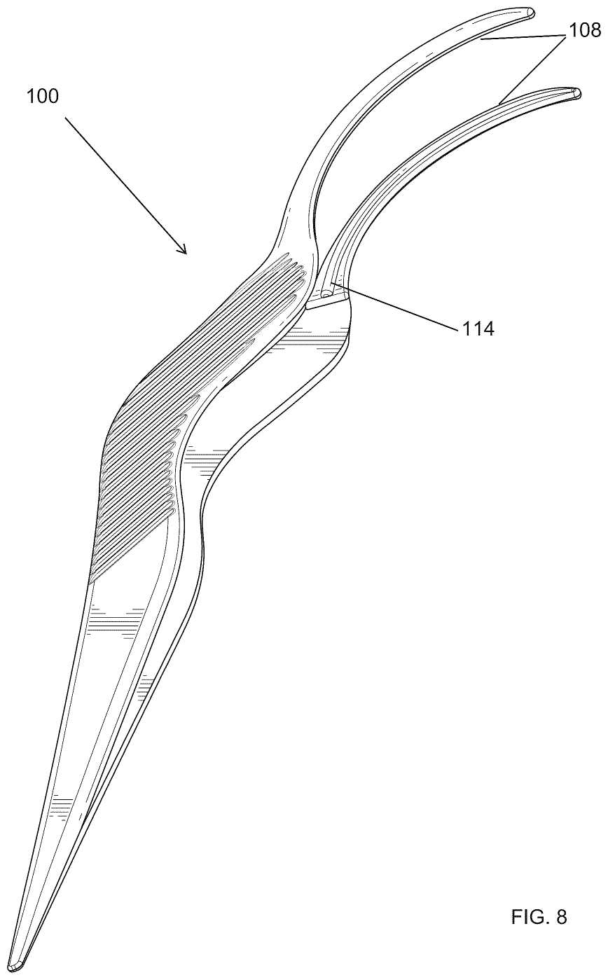

FIGS. 1-8 show a plurality of views of an embodiment of an applicator according to this disclosure. In particular, an applicator 100 (e.g., tweezer, tongs) includes a pair of arms 102 having a pair of medial portions 106 and a pair of grasping tips 108. The pair of arms 102 are joined at a common point 104 such that the pair of medial portions 106 are positioned between the common point 104 and the pair of grasping tips 108 and such that the pair of arms 102 define a default position shaped in a V-shape. As such, the pair of arms 102 are in the default position when defining the V-shape via the common point 104. Therefore, the applicator 100 includes the first arm 102 having the first grasping tip 108 that is arcuate and the second arm 102 having the second grasping tip 108 that is arcuate.

Each arm of the pair of arms 102 has an inner side and an outer side such that the inner sides face each other in the default position and such that the pair of arms 102 are symmetrical to each other at the medial portions 106 or at the grasping tips 108. It should be understood that non-symmetrical embodiments are possible.

Each of the medial portions 106 of the pair of medial portions 106 is humped such that a concave shape is defined thereby (e.g., for resting against a user's cheekbone or user's nose bridge). Likewise, each grasping tip 108 of the pair of grasping tips 108 is arcuate such that an arcuate shape is defined thereby. As such, the concave shapes and the arcuate shapes are respectively positionally consecutive and respectively face a same direction respectively lateral to the pair of arms 102. Correspondingly, each medial portion of the pair of medial portions 106 and each grasping tip of the pair of grasping tips 108 consecutively and longitudinally extend such that a valley is defined there between. These valleys respectively longitudinally oppose each other in the default position.

Each medial portion of the pair of medial portions 106 has the outer side that has a textured portion 110, in this case parallel grooves and ridges, but can also be non-textured. The outer sides of the medial portions 106 face opposite directions.

The grasping tips 108 include a first grasping tip 108 and a second grasping tip 108. The first grasping tip 108 has a first inner side hosting, including, or defining a male portion 114 (e.g., projection). Although the male portion 114 is D-shaped, the male portion 114 can be shaped differently (e.g., U-shape, C-shape, V-shape, P-shape, B-shape, or other shape). The male portion 114 can be continuous (e.g., single projection, protrusion, or otherwise) or discontinuous (e.g., set of projections that are positionally proximate one another). The second grasping tip 108 has a second inner side hosting, including, or defining a female portion 112 (e.g., depression). Although the female portion 112 is shaped to receive a D-shape, the female portion 112 can be shaped differently for receiving other shapes (e.g., U-shape, C-shape, V-shape, P-shape, B-shape, or other shape). The female portion 112 can be continuous (e.g., single depression) or discontinuous (e.g., set of depressions that are positionally proximate). In general, the male portion 114 and female portion 112 have reciprocal profiles so that when the grasping tips 108 are closed, the portions 114 and 112 mesh with one another, thereby spreading a fluid adhesive disposed on eyelashes so as to be more evenly distributed to cause the eyelash extensions to appear more natural.

The male portion 114 and the female portion 112 are spaced from one another when the first arm 102 and the second arm 102 are at the default or open position in the V-shape. However, the male portion 114 and the female portion 112 mate (i.e., fit together with an elongated protrusion of the male portion 114 extending into an extended protrusion of the female portion 112) when the first arm 102 and the second arm 102 are in a closed or grasping position. The grasping position is formed when the first grasping tip 108 and the second grasping tip 108 are moved closer to each other from the default position by a user squeezing the arms 102 together. For example, in the grasping position, the first arm 102 and the second arm 102 can form an I-shape. Likewise, the first grasping tip 108 and the second grasping tip 108 can be moved away from each other toward the default position by a user reducing pressure to the first grasping tip 108 or to the second grasping tip 108 or to at least one of the medial portions 106, which can be at that respective textured portion 110. As such, the arms 102 can resiliently move or be biased to move between the grasping position and the default position (e.g., from grasping position to the default position).

The applicator 100 can be used to perform a process of applying false eyelashes to natural eyelashes. A user may initially apply an adhesive to a natural lash to which the lash extension is to be applied by using a mascara wand or otherwise. Alternatively, the adhesive may be applied to the lash extension prior to applying the lash extension to the natural lash. The process can include causing a lash extension (or another object) to be resiliently grasped (e.g., by hairs, by base) via clamping between the male portion 114 of the first inner side of the first arcuate grasping tip 108 of the first arm 102 of the applicator 100 and the female portion 112 of the second inner side of the second arcuate tip 108 of the second arm 102 of the applicator 100 while the male portion 114 and the female portion 112 mate and the first inner side faces the second inner side. Further, the method can include causing the lash extension (or another object) to be released or placed onto a natural lash of the user (e.g., upper or lower side of upper or lower natural lash). Therefore, the method can enable a self-application of the lash extension via the applicator 100. In an alternative embodiment, a user may use his or her fingers to apply the lash extensions to the natural lashes with the adhesive applied to the natural lashes and/or lash extensions. As such, since the first arm 102 has a first longitudinally extending non-tip portion (e.g., medial portion 106) and the second arm 102 has a second longitudinally extending non-tip portion (e.g., medial portion 106), then the first longitudinally extending non-tip portion and the second longitudinally extending non-tip portion can be lateral to the natural lash (e.g., to right thereof or to left thereof) when the lash extension is released onto the natural lash (e.g., for adhering, magnetizing, fastening, securing).

After the lash extension(s) are placed onto the natural eyelash and weakly adhered thereto by an adhesive, the user may squeeze the tips 108 with the male portion 114 and female portion 112 on the natural lashes and lash extensions, thereby causing the adhesive to better connect the lash extensions to the natural lashes by more evenly distributing the adhesive as the portions 114 and 112 are pressed together. And, because the male portion 114 and female portion 112 may be non-stick material or coated with a non-stick material, the adhesive may not or minimally stick to the portions 114 and 112.

The adhesive, which can be pressure-sensitive, may be a waterproof (semi-permanent) glue, mascara, or some other co-polymer solution having an adhesive quality. Although latex-based adhesives are generally avoided to avoid irritation of the individual's eyelid (e.g., due to an allergic reaction), adhesives can include various other natural and/or chemical ingredients. Examples of possible adhesives include: Arcrylates/ethylhexyl acrylate copolymer, aqua, propylene glycol, ceteareth-25, hydrogenated castor oil, glycerin, phenoxyethanol, 2-bromo-2-nitropropane-1,3-diol, methylcholoroisothiazolinone, methylisothiazolinone, methylparaben, and optionally a color agent (e.g., black 2 (C177266)); Polyterpene, styrene/isoprene copolymer, petrolatum, polyisobutene, microcrystalline wax (cera microcristalina, cire microcrystalline), hydrogenated styrene/methyl styrene/indene copolymer, styrene/VA copolymer, and optionally an antioxidant (e.g., butylated hydroxytoluene (BHT)); Chlorine dioxide, p-anisic acid, biotin, lavandula angustifolio oil, propylene glycol, water, 2-ethylhexyl acrylate, and optionally a preservative (e.g., benzalkonium chloride); and Acrylate copolymer and water. Note that many other adhesive compositions are possible and, in fact, may be desirable for individuals having certain allergies, desiring certain fixation duration (also referred to as “permanency” of the lash extensions), or other use cases.

Semi-permanent clusters of lash extensions may be applied with a Federal Drug Administration-approved (FDA-approved) adhesive that achieves a strong bond. Such adhesives generally include cyanoacrylate. Different types of cyanoacrylates (e.g., ethyl, methyl, propyl, butyl, and octyl) have been designed for bonding to different surfaces. For example, adhesives made from methyl-2-cyanoacryIateare are designed to bond a smooth surface (e.g., the lash extension) to a porous surface (e.g., the natural eyelash), but not on the skin as it may cause irritation.

The adhesive may be a semi-permanent glue or mascara. The adhesive can include an oil-soluble polymer or a water-soluble polymer that helps to enhance adhesion and substantivity of the lash extension to the natural eyelashes. The adhesive may be a waterproof formulation that allows the set of lash extensions to remain affixed to the natural lashes for longer periods of time (e.g., days, weeks, or months).

Although latex-based adhesives are generally avoided to avoid eyelid irritation (e.g., due to an allergic reaction), adhesives can include various other natural ingredients (e.g., sugar or honey) and/or chemical ingredients. For example, copolymer is often a main ingredient in many adhesive formulations. The adhesive could be a commercially available adhesive for conventional lash extensions or a specialized composition for use with the set of lash extensions described herein. The adhesive could be clear or colored (e.g., milky white or black to emulate mascara).

The male portion 114 may include one or more protrusions (e.g., one or more protrusions that extend along the inside wall of one of the grasping tips 108) and may be assembled with the first inner side (e.g., fastened, adhered, mated, magnetized, bolted, stapled, nailed, brazed, heat bonded, formed or defined by an inner surface of the grasping tip 108). The female portion 112 may include one or more depressions (e.g., one or more grooves that extend along the inside wall of the other one of the grasping tips 108) and may be assembled with the second inner side (e.g., fastened, adhered, mated, magnetized, bolted, stapled, nailed, brazed, heat bonded, formed or defined by an inner surface of the grasping tip 108). The male portion 114 can be monolithic with the first inner side (e.g., formed from same material). The female portion 112 can be monolithic with the second inner side (e.g., formed from same material).

The male portion 114 or the female portion 112 can be or can avoid being coated with a friction enhancing or reducing coating. For example, a friction enhancing coating can be rubber. Alternatively, the friction reducing coating can be polytetrafluoroethylene (PTFE), silicon, or others. The male portion 114 or the female portion 112 can be treated (e.g., by being powder coated) to improve durability, resistance to scratching, cleanability, resistance to chemicals/solutions, lash extension stickiness, lash extension adhesion, or others. For example, the male portion 114 or the female portion 112 may have a non-stick surface to avoid stickiness or limit the ability to retain adhesive used to apply the lash extensions after squeezing or pinching the tips 108 onto the lashes with the adhesive. Examples of non-stick coatings include PTFE coatings, silicone coatings, or others.

The applicator 100 may be partially or entirely composed of metal (e.g., aluminum, iron, gold, silver, titanium, copper), alloy (e.g., stainless steel, brass), plastic, or some other material (e.g., wood). For example, in some embodiments the applicator 100 may have a smooth powder coating (e.g., for aesthetics and improved cleanability), while in other embodiments the applicator 100 includes a recyclable (i.e., disposable) plastic body that is not intended for significant durations of use (e.g., months or years). For example, in some embodiments plastic may be desirable because it is recyclable and resistant to the adhesives typically applied to the lash extensions before fixation to the natural lashes. For example, the applicator 100 can be composed of metal, plastic, or any other suitable material. Metal alloys (e.g., stainless steel) are typically preferred because they provide greater durability and allow the applicator 100 to have high precision. The term “precision” can refer to the size of objects that can be grasped by the applicator 100. Highly precise grasping tools (e.g., tweezers) can grab very small objects. In order to have high precision, the arms 102 can be precisely aligned and balanced so that an individual can grasp individual artificial lashes. Other materials may also be used to form the applicator 100. For example, the pair of 102 may include of plastic, glass, foam, or other suitable materials. Moreover, the applicator 100 may be formed from a single piece of material rather than a pair of separate fragments. In such embodiments, the single piece of material can be formed into a V-shaped body having opposed arms 102 and the common point 104, i.e., an apex (e.g., via application of heat to central point at which single piece of material is folded).

As shown in FIGS. 1-8, the applicator 100 can be used for applying an artificial lash extension where the applicator 100 has a textured central portion 100 and an arcuate tip 108 that has an internal male 112 or female 114 portion. The applicator 100 has a pair of arms 102 (e.g., metal, plastic) coupled to each other at a common point 104 (e.g., fused, bonded, molded) such that the arms 102 define a V-shape in a default position. Each of the arms 102 has a central portion 106 that is humped and a tip portion 108 that is arcuate. The artificial lash extension can be manufactured manually or automatically (e.g., an industrial machine that feeds or drops or deposits a plurality of artificial lashes onto a surface, applies an electrical charge to the artificial lashes such that the artificial lashes are oriented in a same direction, apply a heating element or hot fluid to common end areas of the artificial lash extensions such that the artificial lash extensions are fused in those to form a cluster of artificial lash extensions is formed).

At least one of the central portions 106 has an external textured portion 110 (e.g., parallel lines, intersecting lines) to help in finger grasping, although at least one of the central portion can be non-textured, such as smooth or otherwise. At least one of the central portions 106 can lack the external textured portion as well. The textured portion 110 can be textured in various ways, such as knurled, hatched, spiked, bumped, or others, whether inward or outward.

At least one of the tip portions 108 can be structured to have an arcuate longitudinal extension that corresponds to an arcuate, longitudinal and outward extension of an external side of an outer sidewall of a case hosting a plurality of artificial lash extensions, as described herein. For example, when both of the tip portions 108 arcuately and longitudinally correspond to the external side of the outer sidewall, then this configuration can enable the tip portions 108 to grasp several of the artificial lash extensions simultaneously from the case. For example, the arcuate longitudinal extension of at least one of the tip portions 108 can structurally correspond or match the curvature of the upper eyelid, which can include an upper waterline or tightline of a user. The tip portions 108 and female/male portions 112/114 may be configured such that when the arms 102 are forced together by

The tip portions 108 have opposing inner sides that host female/male portions 112, 114 operative for mating engagement with each other when the tips 108 are moved toward each from the default position via the application of force to the central portions 106 in order to grasp an item, such as an artificial lash extension from a case, via the tip portions 108. The female/male portions 112, 114 may extend along the longitude of the tips 108 in a continuous (e.g., solid line or scattered pattern) or discontinuous manner (e.g., broken line or scattered pattern). As shown, the left arm 102 has a female portion 112 (e.g., U-shape in cross-section) and the right arm 102 has a male portion 114 (e.g., D-shape in cross-section) although this arrangement can be reversed or varied.

The female/male portions 112, 114 can provide a crimping or clamping mechanism, which allows more efficient or impactful or forceful fusion or aid, enable, or cause spreading of the adhesives (e.g., along male projections, within female depressions) so as to make the adhesives less visible (e.g., minimize clumping of adhesives). The crimping or clamping mechanism with the female/male portions 112, 114 may improve fusion of an artificial lash extension with a natural lash by more evenly distributing the adhesive, which may be a relatively soft or fluid adhesive (e.g., ethylhexyl acrylate copolymer) as compared to an adhesive that cures in a hard state (e.g., cyanoacrylates). In an embodiment, a male-to-male portion 114, 114 or female-to-female portion 112, 112 arrangements are possible. Likewise, a male or female portion-to-smooth or flat portion is possible, as well. The female/male portions 112, 114 may be configured to operate as a fusing tool (i.e., a tool to fuse lash extensions to natural lashes) as opposed to a tool configured to shape a lash. The tip portion 108 can be unitary with the central portion 106 or made of same material as the central portion 106 (e.g., metal, alloy, rubber, plastic, etc.). The tip portion 108 can have an inner side that is coated with a friction enhancing or decreasing material (e.g., rubber, plastic, foam, silicon, PTFE, etc.) or the inner side can include a textured portion (e.g., parallel lines, intersecting lines) to help in item grasping, although the inner side can be non-textured, such as smooth or others. The textured portion can be textured in various ways, such as knurled, hatched, spiked, bumped, or otherwise, whether inward or outward.

The tip 108 can be encased in a sock-shaped, tubular, and flexible sheath (e.g., plastic, rubber). When the applicator 100 is used and the arms 102 are pushed inward via the central portions 106 from the default position such that the tips 108 move toward each other to grasp an item, such as an artificial lash extension from a case, the central portions 106 may be configured not to contact each other, thereby defining a gap there between. Note that the applicator 100 can be configured to clamp or crimp. For example, the applicator 100 can clamp when the applicator 100 hosts a ratcheting mechanism (e.g., gear and pawl) between the arms 102 that controls inward movement of the arms 102 when the arms are pushed inward via the central portions 106 from the default position such that the tips 108 move toward each other to grasp an item and then remain in that position, which can include the grasping position, if the arms 102 are let go or the application of forces ceases.

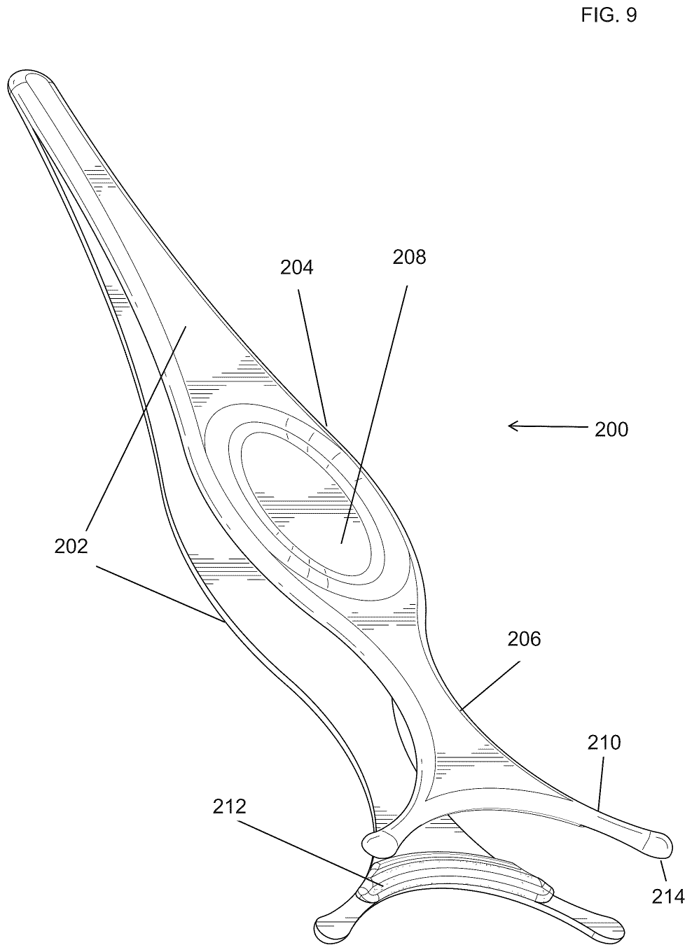

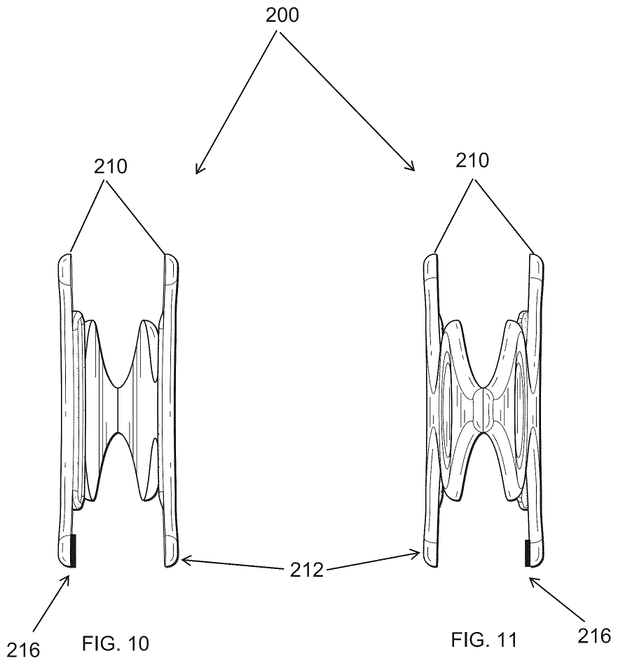

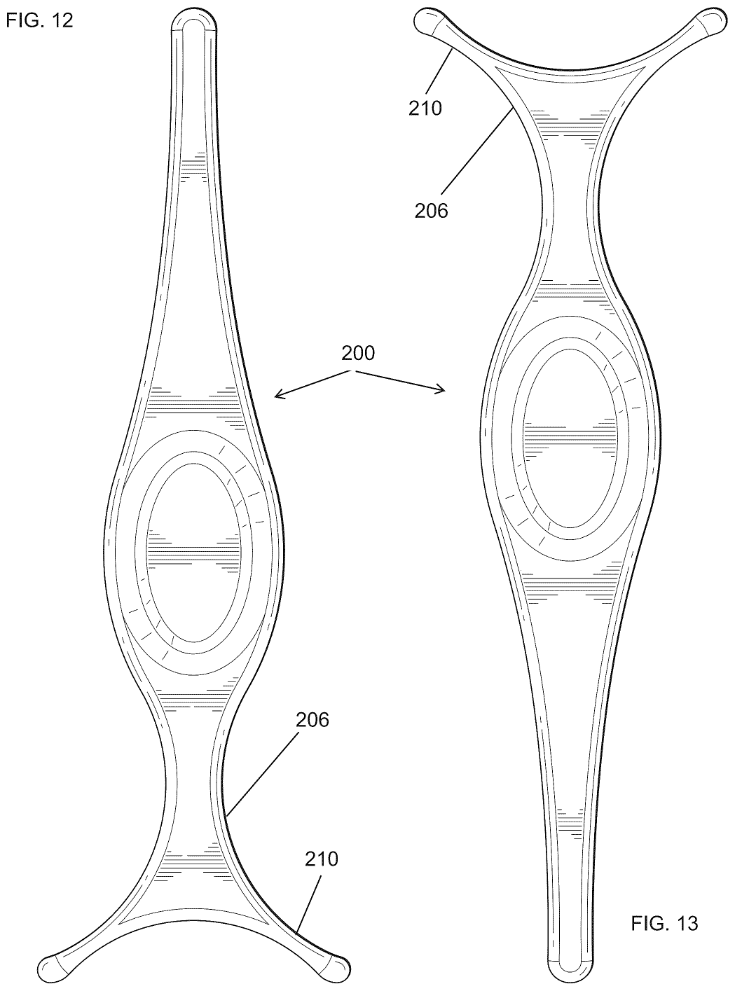

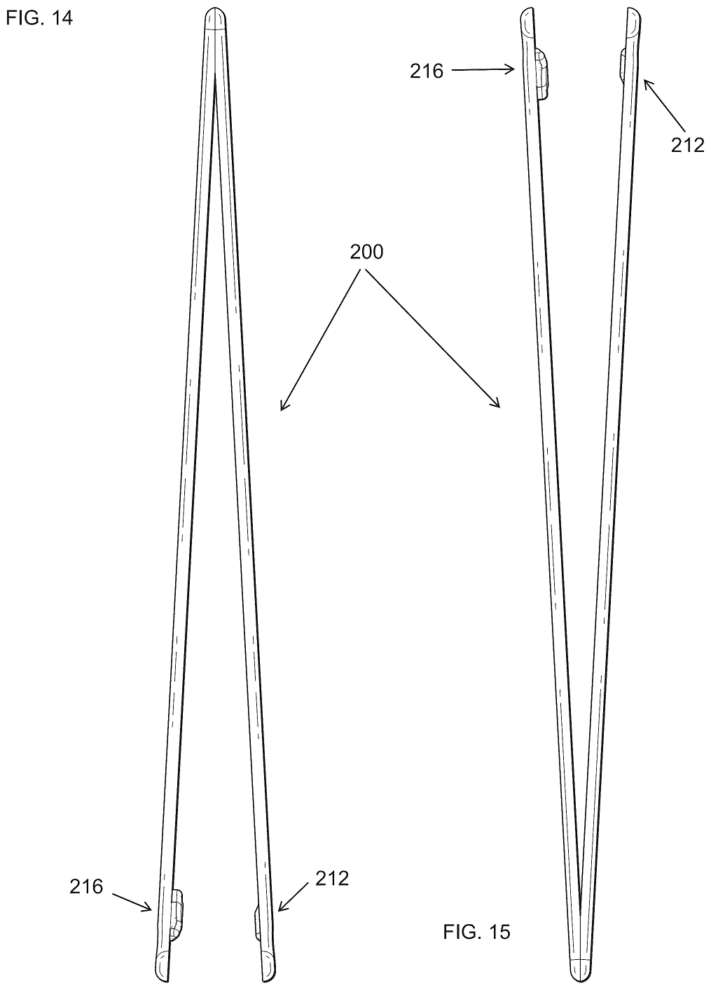

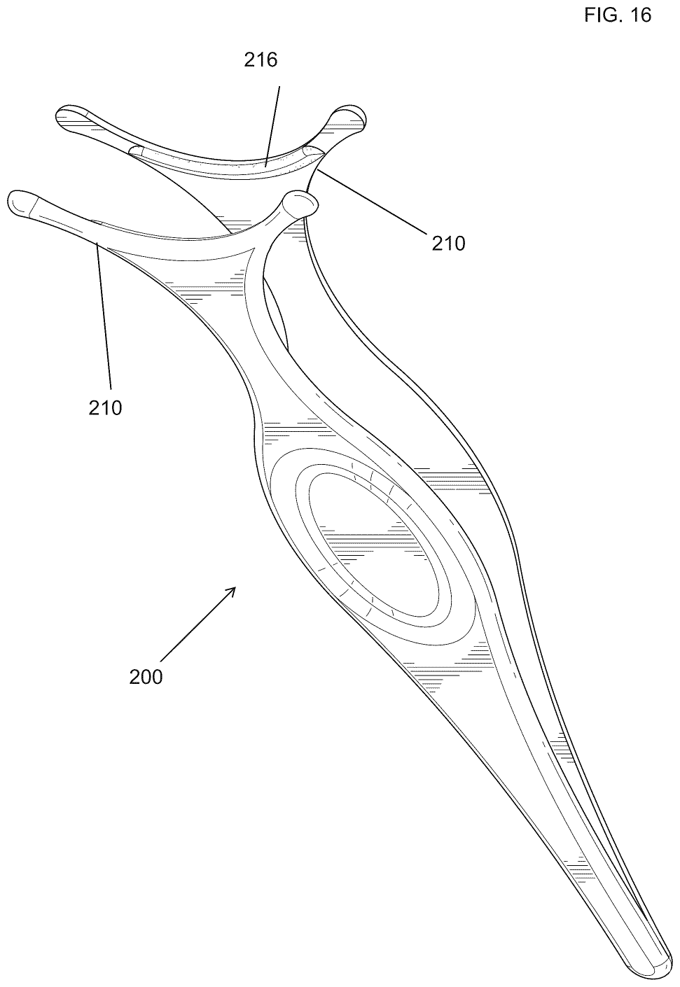

FIGS. 9-16 show a plurality of views of an embodiment of an applicator according to this disclosure. In particular, an applicator 200 can be similar in functional operation to the applicator 100 with a different shape. In particular, the applicator 200 has a pair of arms 202, a pair of medial portions 204, a pair of tips 206, a dimpled portion 208, a pair of arcuate portions 210, a female portion 212, a plurality of pairs of bulges 214, a male portion 216. As such, the first grasping tip 206 or the second grasping tip 206 can be respectively transverse or at least partially perpendicular to the first arm 202 and/or the second arm. Further, at least one of the medial portions 204 is dimpled via the dimpled portion 208. Also, the dimpled portion 208 can be textured, as in the applicator 100. Moreover, the first arcuate portion 210 defining a first grasping tip is bulged on both ends thereof and the second arcuate portion 210 defining a second grasping tip may be bulged on both ends.

The applicator 100 can be used to perform a process of applying false eyelashes to natural eyelashes. A user may initially apply an adhesive to a natural lash to which the lash extension is to be applied by using a mascara wand or otherwise. Alternatively, the adhesive may be applied to the lash extension prior to applying the lash extension to the natural lash. The process can include causing a lash extension (or another object) to be resiliently grasped (e.g., by hairs, by base) via clamping between the male portion 216 of the first inner side of the first arcuate portion 210 of the first arm 202 of the applicator 200 and the female portion 212 of the second inner side of the second arcuate portion 210 of the second arm 202 of the applicator 200 while the male portion 216 and the female portion 212 mate and the first inner side faces the second inner side. Further, the method can include causing the lash extension (or another object) to be released or placed onto a natural lash of the user (e.g., upper or lower side of upper or lower natural lash). Therefore, the method can enable a third-party-application of the lash extension via the applicator 200. In an alternative embodiment, a user may use his or her fingers to apply the lash extensions to the natural lashes with the adhesive applied to the natural lashes and/or lash extensions. Since the first arcuate portion 210 is transverse to the first arm 202 and the second arcuate portion 210 is transverse to the second arm 202, then the first arm 202 and the second arm 202 longitudinally extend away from the natural lash when frontal to the natural lash and when the lash extension is released or placed onto the natural lash.

As shown in FIGS. 9-16 the applicator 200 can be used for applying an artificial lash extension where the applicator 200 has a dimpled central portion 208 and a pair of “snail-head” shaped arcuate portions 210 that have female or male portions 212, 216 disposed on inside surfaces of the second arcuate portion 210. The applicator 200 has a pair of arms 200 (e.g., metal, plastic) coupled to each other at a common point (e.g., fused, bonded, molded) such that the arms define a V-shape in a default position. Each of the arms 202 has the central portion 204 that is inwardly dimpled at the dimpled portion 208 so as to help a user operate the applicator 200 and a tip portion 210 that is arcuate (e.g., C-shaped, V-shaped, U-shaped) and bulged on opposing arcuate ends 214. It should be understood that the bulging at the ends 214 is illustrative, and alternative embodiments may not include the bulged ends 214. The dimpled portion 208 can be textured (e.g., parallel lines, intersecting lines) to help in finger grasping, although the dimpled portion 208 can be non-textured, such as smooth or others. The dimpled portion 208 can be textured in various ways, such as knurled, hatched, spiked, bumped, or others, whether inward or outward.

At least one of the tip portions 210 can be structured to have an arcuate longitudinal extension that corresponds to an arcuate, longitudinal and outward extension of an external side of an outer sidewall of a case hosting a plurality of artificial lash extensions, as described herein. For example, when both of the tip portions 210 arcuately and longitudinally correspond to the external side of the outer sidewall, then this configuration can enable the tip portions 210 to grasp several of the artificial lash extensions simultaneously from the case. For example, the arcuate longitudinal extension of at least one of the tip portions 210 can structurally correspond or match the curvature of the upper eyelid, which can include the upper waterline or tightline of the user on which lash extensions are being placed.

The arcuate portions 210 have opposing inner sides that host female/male portions 212, 216 operative for mating engagement with each other when the arcuate portions 210 are moved toward each from the default position via the applications of force to the central portions 204 in order to grasp an item, such as an artificial lash extension from a case, via the arcuate portions 210. The male/female portions 212, 216 can be extending along the longitude of the arcuate portions 210 in a continuous (e.g., solid line or scattered pattern) or discontinuous manner (e.g., broken line or scattered pattern). As shown, the left arm 202 has a female portion 212 (e.g., U-shape in cross-section) and the right arm 202 has a male portion 216 (e.g., D-shape in cross-section) although this arrangement can be reversed. The male/female portions 212, 216 provide a crimping or clamping mechanism, which allows more efficient or impactful or forceful fusion or aid, enable, or cause spreading of the adhesives (e.g., along male projections and within female depressions or indentations) so as to make the adhesives less visible (e.g., minimize clumping of adhesives). The crimping or clamping mechanism with the female/male portions 212, 216 may improve fusion of an artificial lash extension with a natural lash by more evenly distributing the adhesive, which may be a relatively soft or fluid adhesive (e.g., ethylhexyl acrylate copolymer) as compared to an adhesive that cures in a hard state (e.g., cyanoacrylates). In an embodiment, a male-to-male portion 216 or female-to-female portion 212 arrangements are possible. Likewise, a male or female portion-to-smooth or flat portion is possible, as well. The female/male portions 212, 216 may be configured to operate as a fusing tool (i.e., a tool to fuse a lash extension formed of multiple fibers to natural lashes) as opposed to a tool configured to shape a lash. The arcuate portion 210 can be unitary with the central portion 204 or made of same material as the central portion 204 (e.g., metal, rubber, plastic, etc.). The arcuate portion 210 can have an inner side that is coated with a friction enhancing or reducing material (e.g., rubber, plastic, foam, silicon, PTFE, etc.) or the inner side can include a textured portion (e.g., parallel lines, intersecting lines) to help in item grasping, although the inner side can be non-textured, such as smooth or others. The textured portion can be textured in various ways, such as knurled, hatched, spiked, bumped, or others, whether inward or outward.

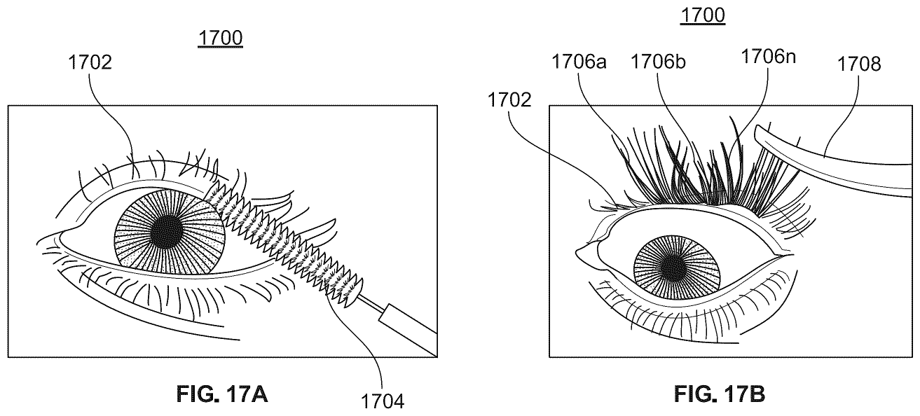

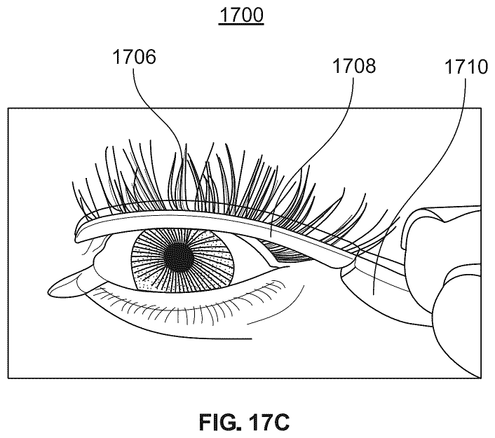

FIGS. 17A-17C show a sequence of respectively applying an adhesive to natural lashes, positioning lash extensions on the natural lashes, and using an applicator to fuse the lash extensions to the natural lashes by evenly distributing the adhesive with male/female features on the tips. The process may start in FIG. 17A, where an eye 1700 including natural eyelashes 1702 may have an adhesive applicator 1704 apply a flexible adhesive to the natural lashes 1702 to the lower side of the natural lashes. The adhesive applicator 1704 may be a conventional mascara wand or a wand that is specifically designed to apply the flexible adhesive. Although the application of the adhesive by the adhesive applicator 1704 may be relatively even across the natural lashes 1702, the adhesive may have some level of inconsistency (e.g., globs or more adhesive in some areas and less in other areas of the natural lashes). As a result of the adhesive being soft and fluid, a user may be able to spread or redistribute the adhesive later on (see FIG. 17C).

As shown in FIG. 17B, after the adhesive has been applied to the natural eyelashes 1702 (or alternatively or additionally to the upper side of the lash extensions) in FIG. 17A, lash extensions 1706a-1706n (collectively 1706) may be placed on a lower side of the natural eyelashes 1702, such that an upper side of the lash extensions 1706 is tacked or otherwise attached to the natural eyelashes 1702 by contacting the lash extensions 1706 to the adhesive on the natural lashes 1702 (or the adhesive on the lash extensions 1706 to the natural lashes 1702). Because the lash extensions 1706 in this case are light (e.g., heat-fused fibers), the tackiness of the adhesive may be sufficient to hold the lash extensions 1706 in place. In placing the lash extensions 1706, a user may hold one more set of the lash extensions 1706 by a tip 1708 including a first and second tip extending from first and second arms of an applicator 1710, as previously provided. The tip 1708 may have protrusions and recessions disposed on respective inside surfaces of the tip 1708.

As shown in FIG. 17C, the user may rotate the applicator 1710, such that a curvature of the tip 1708, which in this case has an arcuate shape, may extend along the natural eyelashes 1702 and lash extensions 1706, where one of the tips may be on one side of the natural lashes 1702 and the other one of the tips may be on the other side of the natural lashes 1702. As the user applies force to the arms of the applicator 1710 to cause the first tip and second tip to simultaneously squeeze or apply force to the adhesive, natural lashes 1702, and lash extensions 1706 so as to cause the adhesive to be distributed along a channel formed by the depression of the female portion of one of the tips as the protrusion of the male portion of the other one of the tips extends into the depression. That is, the soft adhesive will be more evenly distributed along the natural lashes 1702 and lash extensions 1706, thereby fusing the natural lashes 1702 and lash extensions 1706 together in a more seamless way. The squeezing of the tips may also cause the lash extensions 1706 to be better matted to the natural lashes 1702.

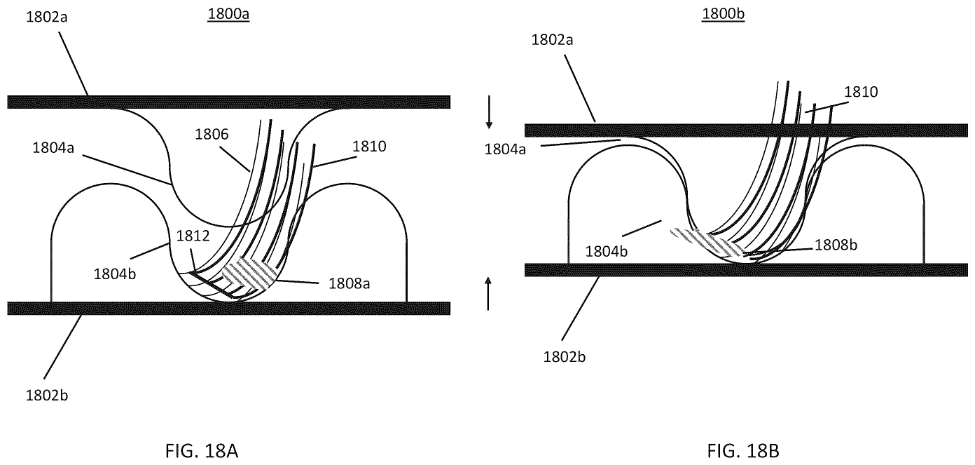

FIGS. 18A-18B show a sequence of using tips with male/female features of an applicator to fuse natural lashes and lash extensions. As shown in FIG. 18A, an open state 1800a, which may be a default state, of tips 1802a and 1802b (collectively 1802) of an applicator results in a separation between a protrusion 1804a that defines a male portion and a depression or recess 1804b that defines a female portion, where the protrusion 1804a and recess 1804b may be disposed on the respective tips 1802a and 1802b. The protrusion 1804a may be elongated and extend along the tip 1802a, and the recession 1804b may be elongated and extend along the tip 1802b. Natural lashes 1806 may have an adhesive applied to the underside, for example, of the natural lashes 1806 to form an adhesive region 1808a. A lash extension 1810 may be placed or contacted with the natural lashes 1806 and held by the tackiness of the adhesive in the adhesive region 1808a. The lash extension 1810 is shown to have a base 1812, which, in one embodiment, may be heat-fused so as to be thin (e.g., between 0.05 mm and 0.15 mm). It should be understood that alternative lash configurations may be utilized.

As shown in FIG. 18B, as the protrusion 1804a of the male portion is pressed into the depression 1804b of the female portion with the natural lashes 1806 and lash extension 1810 being held by the adhesive, the adhesive region 1808a may be compressed and traverse within a channel formed between the protrusion 1804a and depression 1804b, thereby causing the adhesive region 1808a to be redistributed to become adhesive region 1808b. The adhesive region 1808b may result in a more evenly distributed adhesion region, thereby causing a fusion between the natural lashes 1806 and lash extension 1810 to be stronger.

Another embodiment of a process for applying lash extensions to natural lashes may include causing an adhesive holding the lash extension formed of multiple fibers and natural lashes together to be simultaneously grasped between at least one protrusion defining a male portion of a first inner side of a first tip of a first arm disposed on an applicator and at least one depression that defines a female portion disposed on a second inner side of a second tip of a second arm of the applicator, thereby causing the adhesive to be spread along a region between the male and female portions.

The process may further include comprising causing the male and female portions to separate after being simultaneously grasped, thereby causing the lash extension to be adhered to the natural lashes with the adhesive more evenly distributed across the lash extension and natural lash. In simultaneously grasping, the first and second tips may be aligned to extend longitudinally across the natural lashes of an eye prior to simultaneously grasping.

One embodiment of a method for redistributing an adhesive applied to a lash extension formed of multiple fibers and natural lashes may include causing the adhesive disposed on the natural lashes and lash extension to extend along a surface of an elongated depression disposed on a first tip of a first arm of an applicator and a surface of an elongated protrusion disposed on a second tip of a second arm when the elongated protrusion is vertically extended into the elongated depression with the adhesive, natural lashes, and lash extension being positioned between the elongated depression and elongated protrusion. The process may further include causing the adhesive to have reduced adhesion to either of the surfaces of the elongated depression or elongated protrusion

One embodiment of a method of manufacturing an applicator may include forming a first arm including a first grasping tip having a first inner side including at least one protrusion that defines a male portion, and forming a second arm including a second grasping tip having a second inner side including at least one depression that defines a female portion. The first and second arms may be connected at a first end opposite a second end at which the first and second grasping tips are located, and with the first inner side facing the second inner side. The male portion and the female portion may be aligned with one another so that when the first arm and the second arm are in an open position, the male and female portions are separated from one another, and when the first arm and second arm are in a closed position, the male portion and the female portion mate with one another.

Forming the first arm may include applying the male portion to the first inner side, and forming the second arm may include applying the female portion to the second inner side. Forming the first arm may include forming the male portion on the first inner side of the first grasping tip, and forming the second arm may include forming the female portion on the second inner side of the second grasping tip.

It should understood that the applicators be embodied in many different forms and should not be construed as necessarily being limited to the embodiments disclosed herein. Rather, the embodiments provided herein are provided so that this disclosure is thorough and complete, and fully conveys various concepts of this disclosure to skilled artisans.

Various terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

As used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the embodiments.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from the teachings of the present disclosure.

Furthermore, relative terms such as “below,” “lower,” “above,” and “upper” can be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings were turned over, then the elements described as being on the “lower” side of other elements would then be oriented on “upper” sides of the other elements. Similarly, if the device in one of the figures were turned over, elements described as “below” or “beneath” other elements would then be oriented “above” the other elements. Therefore, the example terms “below” and “lower” can encompass both an orientation of above and below.

The terminology used herein is for describing particular example embodiments and is not intended to be necessarily limiting of the present disclosure. As used herein, the singular forms “a,” “an” and “the” are intended to include the plural forms as well, unless the context clearly indicates otherwise. Also, as used herein, the term “a” and/or “an” shall mean “one or more,” even though the phrase “one or more” is also used herein. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof. Furthermore, when the present disclosure states herein that something is “based on” something else, then such statement refers to a basis which may be based on one or more other things as well. In other words, unless expressly indicated otherwise, as used herein “based on” inclusively means “based at least in part on” or “based at least partially on.”

Features described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity in any manner.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing, and/or other any other types of manufacturing. For example, some manufacturing processes include three dimensional (3D) printing, laser cutting, computer numerical control routing, milling, pressing, stamping, vacuum forming, hydroforming, injection molding, lithography, and so forth.

Any and/or all elements, as disclosed herein, can be and/or include, whether partially and/or fully, a solid, including a metal, a mineral, a gemstone, an amorphous material, a ceramic, a glass ceramic, an organic solid, such as wood and/or a polymer, such as rubber, a composite material, a semiconductor, a nanomaterial, a biomaterial and/or any combinations thereof. Any and/or all elements, as disclosed herein, can be and/or include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, opaqueness, luminescence, reflection, phosphorescence, anti-reflection and/or holography, a photo-sensitive coating, an electronic and/or thermal property coating, such as for passivity, insulation, resistance or conduction, a magnetic coating, a water-resistant and/or waterproof coating, a scent coating and/or any combinations thereof. Any and/or all elements, as disclosed herein, can be rigid, flexible, and/or any other combinations thereof. Any and/or all elements, as disclosed herein, can be identical to and/or different from each other in material, shape, size, color and/or any measurable dimension, such as length, width, height, depth, area, orientation, perimeter, volume, breadth, density, temperature, resistance, and so forth.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

As used herein, the term “about” and/or “substantially” refers to a +/−10% variation from the nominal value/term. Such variation is always included in any given value/term provided herein, whether or not such variation is specifically referred thereto.

If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

Although preferred embodiments have been depicted and described in detail herein, skilled artisans can make various modifications, additions, substitutions and the like can be made without departing from this disclosure, and these are, therefore, considered to be within scope of this disclosure, as claimed.

1. An applicator for an artificial lash extension comprising:
a pair of opposing arms comprising a first arm and a second arm, wherein the first arm and the second arm are joined at proximal ends to form a hinge, each of the first and second arms comprising:
a first side opposite a second side, and an interior surface opposite an exterior surface, wherein the interior surface and the exterior surface extend between the first side and the second side;
a medial section extending distally from the proximal end; and
a grasping section extending distally from the medial section, the grasping section comprising a first end area that forms a tip, a second end area, and a concave curvature disposed between the first end area and the second end area and along at least part of the second side of the grasping section,
wherein the medial section and the grasping section longitudinally extend toward the tip to position the concave curvature of the grasping section to face opposite the first side;
wherein a portion of the interior surface corresponding to the grasping section of the first arm has a male portion comprising a protrusion having a concave curvature that longitudinally extends toward the tip to position the concave curvature of the male portion to face opposite the first side; and
wherein a portion of the interior surface corresponding to the grasping section of the second arm has a female portion comprising a depression, wherein the male portion and the female portion are designed to crimp natural lashes and the artificial lash extension that are disposed therebetween.

2. The applicator of claim 1, wherein the tip is a single terminal distal end of the applicator.

3. The applicator of claim 1, wherein the male portion and the female portion have reciprocal profiles.

4. The applicator of claim 1, wherein the medial section joins the grasping section at a part of the grasping section that is closer to the second end area than the first end area.

5. The applicator of claim 4, wherein the grasping section extends distally from the medial section at the second end area of the grasping section.

6. The applicator of claim 1, wherein the grasping section comprises a convex curvature disposed between the first end area and the second end area and along at least part of the first side corresponding to the grasping section, wherein the concave curvature of the grasping section is positioned opposite the convex curvature.

7. The applicator of claim 1, wherein the portion of the interior surface corresponding to the grasping section of the first arm has the male portion further comprises a first support that protrudes from the interior surface corresponding to the grasping section of the first arm, wherein the protrusion of the male portion is disposed on the first support.

8. The applicator of claim 7, wherein portions of the first support extend beyond a first side and a second side of the protrusion.

9. The applicator of claim 7, wherein the portion of the interior surface corresponding to the grasping section of the second arm has the female portion further comprises a second support that protrudes from the interior surface corresponding to the grasping section of the second arm.

10. The applicator of claim 9, wherein the depression is disposed within the second support.

11. The applicator of claim 1, wherein the male portion and the female portion are coated with a friction reducing coating.

12. The applicator of claim 1, wherein the male portion is fastened to the first arm, and the female portion is fastened to the second arm.

13. The applicator of claim 1, wherein the male portion is monolithic with the portion of the interior surface corresponding to the grasping section of the first arm, and wherein the female portion is monolithic with the portion of the interior surface corresponding to the grasping section of the second arm.

14. The applicator of claim 1, wherein a portion of the exterior surface corresponding to the medial section of each arm comprises a textured portion.

15. The applicator of claim 14, wherein the textured portion of each arm comprises grooves and ridges.

16. The applicator of claim 1, wherein a first valley is defined at an intersection between the grasping section of the first arm and the medial section of the first arm, and wherein a second valley is defined at an intersection between the grasping section of the second arm and the medial section of the second arm.

17. The applicator of claim 1, wherein the male portion comprises a single continuous protrusion, and wherein the female portion comprises a single continuous depression.

18. The applicator of claim 1, wherein the applicator is configured to transition from an open position to a closed position, in the open position the male portion and the female portion are separated from one another, and in the closed position the male portion and the female portion mate with one another, wherein the open position of the applicator is a default position, and wherein an application of pressure to the exterior surface of each arm of the applicator transitions the applicator from the open position to the closed position.

19. The applicator of claim 18, wherein in the closed position the male portion extends at least in part into the female portion.

20. The applicator of claim 1, wherein the male portion and the female portion of the applicator are designed to redistribute an adhesive that bonds the artificial lash extension to an underside of the natural lashes.
